(19) United States
(12) Patent Application Publication
(10) Pub. No.: US 2004/0257763 A1
(43) Pub. Date: Dec. 23, 2004

(54) Internal hard disc drive scalability using mezzanine backplane technology

(75) Inventors: Mark E. Andresen, Cary, NC (US); Michael G. Brinkman, Raleigh, NC (US); Robert J. Christopher, Chapel Hill, NC (US); John G. Gundlach, Cary, NC (US)

Correspondence Address: DRIGGS, LUCAS BRUBAKER & HOGG CO. L.P.A., DEPT. IRA, 8522 EAST AVENUE, MENTOR, OH, 44060, US

(73) Assignee: International Business Machines Corporation, Armonk, NY

(21) Appl. No.: 10/462,913

(22) Filed: Jun. 17, 2003

(51) Int. Cl. G06F 1/20

(52) U.S. Cl. 361/687

(57) ABSTRACT

A split backplane is used in a network server, thereby permitting the use of more than one channel to connect a server motherboard to one or more hard disc drives. A master card ‘A’ is plugged into each backplane. In turn, one or more additional cards may be stacked parallel to the master card, being joined thereto by a mezzanine connector. The additional card can be another master card ‘A’ or a slave card ‘B’ that performs subordinate functions. Each card is coupled to one or more hard disc drives through a multiple pin connector to transmit SCSI, or similar signals. The ‘A’ and ‘B’ cards are arranged generally parallel with the planar surfaces of the disc drives so as to improve the flow of cooling air as it is drawn through the enclosure or mounting rack past the disc drives.

### FIELD OF THE INVENTION

The present invention relates to servers. More specifically, it relates to improvements in the architecture of such servers, particularly as it relates to the ability to hot swap hard disc drives and other components in the server and to effectively prevent the components from overheating during use.

### BACKGROUND OF THE INVENTION

Business uses for high performance servers place ever growing demands for these servers to perform a variety of tasks. They must be capable of efficiently handling corporate e-mail messaging and workgroup collaboration solutions, as well as data mining, data warehousing and other heavy duty business analysis.

An industry standard in some low-end, mid range and high-end servers is the requirement for hot-swappable hard disc drive (HDD) storage units, necessitated by the need to replace one or more drives because of a defect or the need for an upgrade without suspending the operation of the system. Typically, the HDD electrical interface is achieved using a printed circuit card that provides connector locations for the maximum supported HDD configuration. By including this single backplane with support for a multitude of HDDs, the base system cost necessarily includes the cost of supporting the multiple HDD's, even if not all the HDD bays are immediately populated. With computer costs being so competitive, supporting the maximum configuration of components in a base system configuration becomes a disadvantage when trying to win new business and increase profit margins.

Currently, hard drive backplanes are designed in many configurations based on the available space in the server package. Some are 2×3 (2 rows, 3 columns), 3×1, 1×2, 6×1, etc. The hard drive backplanes are designed in such a way that any drive that is plugged into the backplane is required to be on a single SCSI (small computer system interface) channel. The backplane PCB is positioned perpendicular to the airflow required to cool components down-stream of the hard drives with the connectors soldered normal to the backplane. As computing power density increases, so does the heat that must be forced from the inside of the system to the environment external to the system. To properly draw the heat from the machine, the volumetric air flow through the system must be increased. A backplane oriented normal to the air flow greatly hinders this flow.

The various electronic devices within the server are designed to operate within a certain range of temperatures. If a device, such as a hard disc drive, is required to operate outside of its normal operational temperature range, problems, such as malfunctions, erratic behavior and damage, are likely to occur. Generally speaking, the heat generated by a single HDD is not likely to create a serious problem. The heat could be dissipated by relying on a relatively simple system fan. However, as disc speeds have become faster, the amount of heat generated by the HDD has also increased. This problem is further exacerbated when multiple HDDs are placed in close proximity to one another within an enclosure. For example, a group of HDDs may be set up as a RAID (redundant array of independent discs) or other fixed or random configuration within a confined space. The ability of the system to create an airflow sufficient to cool the individual disc drives becomes encumbered by the blocking effect of the surrounding drive units. Accordingly, the disc drives in this environment may be likely to develop heat-related problems. In the past, attempts have been made to provide adequate cooling using elaborate cooling systems, including refrigeration or cooling fins, or by increasing the spacing between adjacent disc drives. Unfortunately, these methods not only increase the complexity of the system but also increase the overall size of the system, whereas the trend is to miniaturize the systems wherever and whenever possible.

### SUMMARY OF THE INVENTION

It is an objective of the present invention to provide flexibility to have a certain number of drives on one SCSI channel and another number of drives on a different SCSI channel.

Another objective is to provide more effective cooling of components in a computer server, thereby improving signal quality and overall system performance.

Still another objective is to provide a cost savings by reducing the need to provide backplane support in a base system configuration.

Still another objective is to provide the flexibility of having a random number of multiple devices on a single SCSI channel.

These and other objectives and advantages will become apparent upon a reading of the description that follows.

The present invention relates to a server that includes multiple backplanes. Each backplane is connected to at least one hard disc drive either by a master card or a slave card. The card is positioned orthogonally to the backplane generally parallel to the planar surfaces of the disc drives, thereby facilitating the flow of cooling air past each of the disc drives. The master card is connected to a system server from which it receives commands that it relays to the disc drives through a right angle or card edge SCSI connection. Each slave card is arranged parallel to the master card and communicates therewith through a mezzanine connector. With this arrangement of cards, the present invention provides a more effective system for delivering cooling air to an array of disc drives within a server rack or enclosure. It also improves cooling of other system components behind the disc array.

The invention also relates to a computer data storage sub system containing a plurality of hard disc drives. Any of the hard disc drives can be removed and inserted without suspending the operation of the computer. The sub system includes a master card having an interface which carries SCSI signals from a server motherboard or an adapter card installed on the motherboard to and from a first hard disc drive. It also can include another card coupled to the master card and having an interface that carries SCSI signals to and from a second hard disc drive. This second card is parallel to the master card and receives signals and commands from the master card through a mezzanine connector. Cooling means are arranged to provide a flow of air around the hard disc drives, and in a direction that is parallel to the cards. The second card can be another master card or it can be a slave card. More cards can be interfaced with the master card or the slave card through additional mezzanine connectors.

The invention also relates to a split backplane for use in sending signals between a system server and an array of hard disc drives. The backplane comprises multiple cards, each of which communicates with one or more hard drives through a connection, such as an SCSI. The cards are arranged parallel to one another, with one card being a master card that communicates with a server motherboard or other form of command module. The remaining card or cards obtain data and control signals through a mezzanine connector from the master card. The cards are arranged so that the air used to cool the hard disc drives flows in a direction that is parallel to the surfaces of the cards and, thus, is unimpeded by the cards.

During the operation of a computer server system, a method is provided to more effectively cool an array of hard disc drives interconnected to a plurality of generally flat printed circuit cards. The method comprises the operative steps of (a) providing a source of cooling air to draw air over and around the array of disc drives; and (b) arranging the cards with respect to the disc drive so as not to hinder or impede the flow of air. Each of the disc drives in the array has a pair of generally parallel, planar surfaces. The cards are arranged so that the planar orientation of the cards is generally parallel to the planar surfaces of the disc drives. The cooling air is drawn past the array of disc drives and cards using one or more cooling fans.

### BRIEF DESCRIPTION OF THE DRAWINGS

The following illustrations are presented to provide a more complete understanding of the present invention, and to facilitate the description of the same.

FIG. 1 is an exploded front perspective view of four disc drives and two printed circuit cards;

FIG. 2 is an exploded rear perspective view of the disc drives and PC cards;

FIG. 3a shows an exploded view of a master card and two slave cards;

FIG. 3b shows the assembled cards; and

FIG. 4 is a side view, partially sectioned, of an assembly of PC cards, disc drives, and a cooling fan in a rack chassis.

### DETAILED DESCRIPTION OF THE INVENTION

According to the present invention, a single backplane is replaced by two or more separate printed circuit cards. For example, the current implementation of a 9 position HDD backplane consisting of a single backplane with 9 connectors would be replaced by splitting that backplane into three separate cards that can be interconnected to each other. The advantage is that the base server system costs do not include an expensive ‘9’ position backplane. Instead, it includes a less expensive ‘3’ position backplane that can be scaled up through other avenues according to the options offered by the supplier of the server.

The cards described herein are designed in such a way that they are parallel to the required airflow, greatly increasing the air flow efficiency (as well as the cooling efficiency) across the drives and past the backplane.

The cards used with the split backplane are designed in such a way that there can be a multiple number of drives on different channels. This implementation allows users to customize how many drives they want on however many SCSI channels. The only limitation to the customization is that which is inherent to the SCSI electrical bus and/or actual physical limitations of the computer that houses the hard drives.

The invention is further implemented by using two different backplane cards. For the purpose of this description, card ‘A’ will be the main or master card that gets connected to the main server and card ‘B’ is a slave card that plugs into card ‘A’ and/or another card ‘B’ via a mezzanine connection. Using the mezzanine connection and right angle SCSI connectors allows the cards to be stacked one on top of the other in parallel fashion. These cards typically contain connectors, circuit traces, power controls and other devices used in connection with sub-systems of this type. The cards generally are proprietary to the manufacturer of the subsystem, and their content and configuration do not constitute a part of the present invention.

An A, B configuration of cards allows 6 drives on one channel for a 1U server. Another configuration could be A, A 3 drives are on two separate channels with each channel plugged into its own separate connection cable. An A, B, B configuration of cards allows 9 drives on one channel for a 2U server. Other configurations are A, A, B for 3 drives on one channel and 6 on another or A, A, A for 3 drives on 3 different channels. The configuration can be expanded to a 3U, 4U or larger server as needed.

Cost savings are realized when only card A is included in the base server configuration. If a user requires further HDD storage, the system can be upgraded to the required configuration. Also, as will be described in the drawings, these cards are parallel to the airflow.

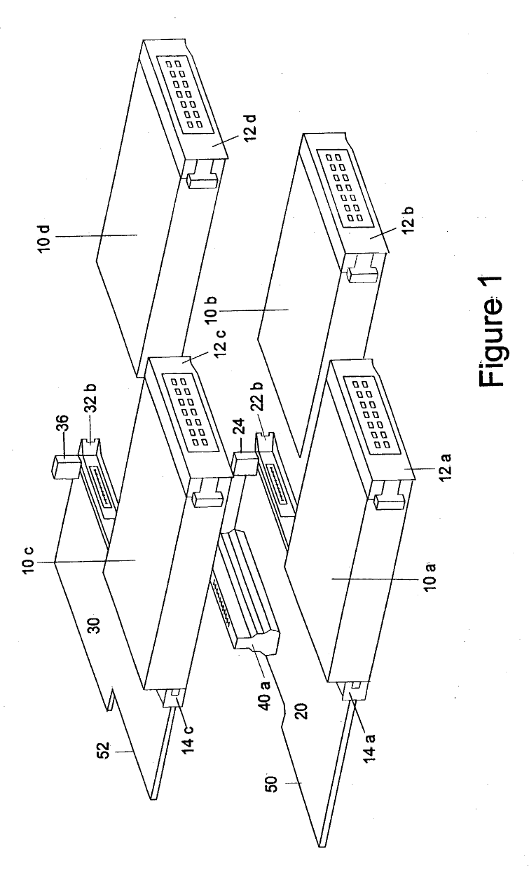

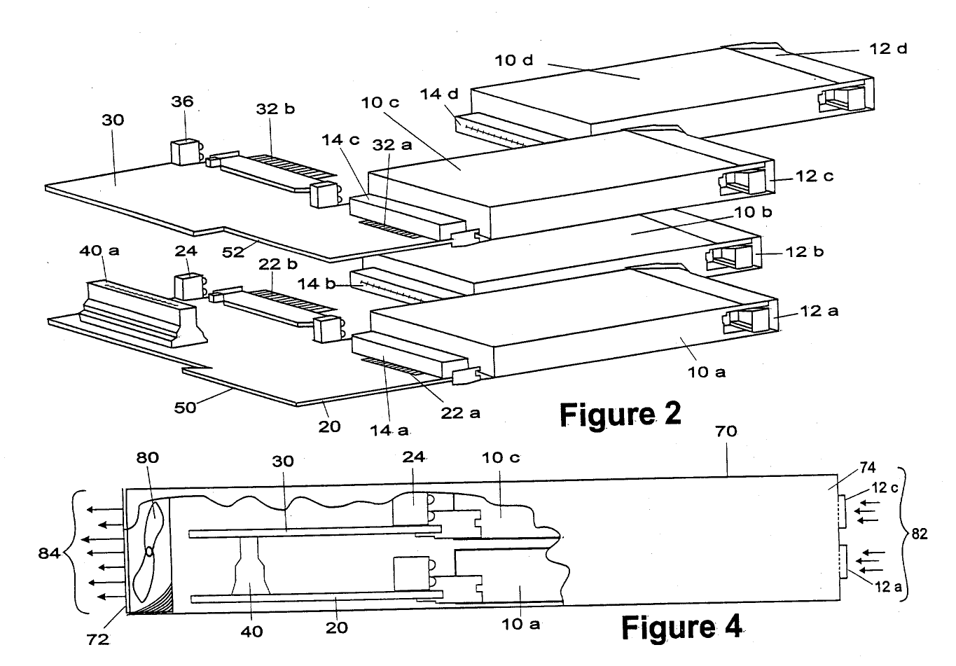

FIGS. 1 and 2 are exploded perspective views looking both at the front and the rear of four hard disc drives 10a, 10b, 10c and 10d, each of which has a female receiver of a connector (two of which 14a, 14c are shown in FIG. 1 and all of which are shown in FIG. 2 as 14a-d). The connectors can be SCSI or a hot swappable version of an IDE or other connectors that may be hot swappable and that are typically used to transmit signals from a motherboard through the ‘A’ and ‘B’ cards to hard disc drives.

The ‘A’ card 20 includes a male part of the connector (not shown in FIG. 1, but shown as 22a in FIG. 2) joined to the corresponding female receiver 14a, to provide the SCSI connection to the hard disc drive 10a, and a second male part 22b adapted to engage the female receiver 14b (FIG. 2) to make an SCSI connection to second disc drive 10b. A slave card ‘B’ 30 has a similar male part of a connector shown as 32a in FIG. 2 engaging a female receiver 14c on a third hard disc drive 10c and a second male part 32b positioned to connect to a female receiver of a connector 14d at the rear of the fourth hard disc drive 10d. Card A 20 transmits information to Card B 30 through a mezzanine connector. This mezzanine connector, comprising a male part 40a on the top surface of the master card 20, and a female receiver (not shown) on the second card 30, provides communication between the two cards while maintaining them positioned parallel to one another. Such connectors are readily available on the commercial market in a variety of pin configurations.

The master card 20 is identified by the rearwardly projecting tab 50 that enables it to be connected to the computer motherboard (not shown) by suitable means, such as a ribbon cable or the like. Likewise, a slave card is readily identified by the cutaway opening or notch 52 whereby it can be stacked with card A 20 without interfering with connections between card A and the motherboard. Spacers 24 are mounted on card A, and serve to separate the two bottom disc drives 10a and 10b from one another. Likewise, spacers 36 on Card B separate the two top disc drives 10c and 10d from one another.

Each of the hard disc drives is equipped with a cooling grid 12a, 12b, 12c and 12d mounted on the end of the drives opposite from the SCSI interconnects. Fans associated with the server (not shown) pull cooling air over and around the disc drives to prevent overheating. Additional cooling fans typically are also required to keep the processor chips and other components from overheating as well.

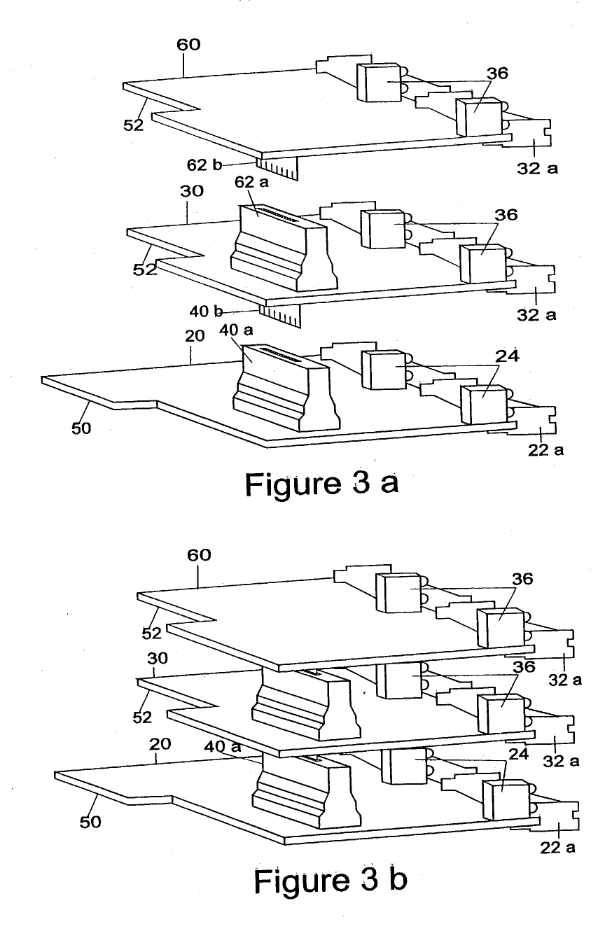

In accordance with the teachings of the present invention, the card sub-assembly is shown unassembled in FIG. 3a and as it is assembled in FIG. 3b. As shown, the component numbers are the same as previously described in connection with FIG. 1. The mezzanine connector 40 shown in the exploded view comprises a female connection 40a on the ‘A’ card 30 and a corresponding male connector 40b on the ‘B’ card 36. The mezzanine connector 40 serves to provide information and commands from the A card 20 to the first B card 30 to control the operation of two drives. A second mezzanine connector 62 joins the first B card 30 to a second B card 60.

FIG. 4 is a partially cut-a-way view of an ‘A’ card 20 and a ‘B’ card 30 and two disc drives 10a, 10c assembled into a chassis 70 of a mounting rack. The cards 20 and 30 communicate through the mezzanine connector 40. The vent grids 12a, 12c are mounted on the front of the chassis 70 or on the hard drives 10a-10d, and exhaust fans 80 are mounted on a rear panel 72 on the chassis or internal to the chassis. The rear panel 72 preferably is hinged or connected for easy removal to facilitate access and service on the PC cards. The disc drives can be readily removed through the front panel 74 of the chassis for service or replacement.

The invention has been described as it relates to a typical SCSI interconnect between the cards and the HDDs. It should be understood that the connection can be through a standard 50 pin, 68 pin or 80 pin connector, or any other specialized interface connector used to transmit SCSI signal. Although the SCSI is exemplary of the invention, it is not limited solely to SCSI. Instead, it should be understood that other types of signals, such as a serial IDE with an 80 pin connector or a serial ATA, or an SES (storage and enclosure services), or a serial SCSI or fiber channel signal transmission busses, can support this system provided that the system has the capacity for the disc drives to be hot swappable.

The method of powering up a hard disc drive during replacement or swapping does not necessarily represent a part of the present invention. However, any of the conventional means for the delivery of power signals to the disc drives, sequentially or simultaneously with the delivery of data and control signals, may be used. Furthermore, it should be understood that the signals can be delivered between the cards and the disc drives through a ribbon cable or directly by using contact points or fingers along an edge of the card that match corresponding contacts on the disc drives.

While the invention has been described in combination with specific embodiments thereof, there are many alternatives, modifications, and variations that are likewise deemed to be within the scope thereof. Accordingly, the invention is intended to embrace all such alternatives, modifications and variations as fall within the spirit and scope of the appended claims.

What is claimed is:

1. A server sub-assembly including
a) a split backplane comprising at least two printed circuit cards;
b) at least two hard disc drives;
c) an interconnect between each card and at least one of the hard disc drives; and
d) a source of cooling air;
said cards positioned generally parallel to the flow of cooling air from the source.

2. The sub-assembly according to claim 1 wherein the first card is a master card adapted to communicate with a system server.

3. The sub-assembly according to claim 2 wherein the second card is a slave card, is connected to the master card in a stacked array through a mezzanine connector, and is adapted to receive instructions through the master card.

4. The sub-assembly according to claim 3 wherein said master card and said slave card are arranged parallel to one another.

5. The sub-assembly according to claim 4 wherein each card is interconnected to a separate hard disc drive.

6. The sub-assembly according to claim 2 wherein the second card is another master card adapted to separately communicate with the system server.

7. The sub-assembly according to claim 6 wherein the two master cards are arranged parallel to one another.

8. The sub-assembly according to claim 7 further including a third card parallel to the master cards and interconnected with one of them through a mezzanine connector, and connected through an interface to a third hard disc drive.

9. The sub-assembly according to claim 1 wherein the source of cooling air comprises at least one fan that serves to draw the cooling air past the hard disc drives through the sub-assembly for discharge into the environment.

10. A computer data storage sub-system containing an array of hard disc drives whereby any of the hard disc drives can be removed and replaced without suspending the operation of the computer, comprising:
a) a generally flat master card having an interface which carries SCSI signals to and from a first hard disc drive;
b) a generally flat second card having an interface which carries SCSI signals to and from a second hard disc drive;
c) cooling means arranged to provide a flow of air around the hard disc drive, said first and second cards, said cards arranged generally parallel to the flow of air.

11. The sub-system according to claim 10 wherein the interface between the two cards and the hard disc drive is a right angle SCSI connector.

12. The sub-system according to claim 11 wherein the second card is another master card and both cards are adapted to interface with a server motherboard through separate cable connections.

13. The sub-system according to claim 11 wherein the second card is a slave card and receives instructions from the master card through a mezzanine connector.

14. The sub-system according to claim 11 wherein the two cards are parallel to one another.

15. The sub-system according to claim 14 further including additional cards, each of which interfaces with another hard disc drive and receives instructions from one of said two cards through a mezzanine connector.

16. The sub-system according to claim 10 wherein the cooling means comprises at least one fan that serves to draw the cooling air past the array of hard disc drives and the cards for discharge into the environment.

17. A method for cooling an array of hard disc drives during the operation of a computer server system, each of said drives connected to a separate printed circuit card, comprising:
providing a source of cooling air to draw air over and around the array of disc drives; and
arranging the cards with respect to the disc drives so that the cards do not impede the flow of air.

18. The method according to claim 17 wherein each of the disc drives in the array has a pair of generally parallel, planar surfaces, and the cards are arranged so that the planar orientation of the cards is generally parallel to the planar surfaces of the disc drives.

19. The method according to claim 17 wherein the cooling air is drawn past the array of disc drives and cards using at least one cooling fan.

20. The method according to claim 17 including the step of connecting a first printed circuit card to a server motherboard as a master card, connecting a second card as a first slave card through a mezzanine connector to the master card, and optionally connecting a second slave card to the first slave card through a second mezzanine connector.

21. The method according to claim 17 including separately connecting first and second printed circuit cards to the server motherboard as master cards.

22. The method according to claim 21 further including the step of connecting a first slave card to one of said master cards through a mezzanine connector, and optionally connecting a second slave card to the first slave card through a second mezzanine connector.
